(19) United States
(12) Patent Application Publication
(10) Pub. No.: US 2006/0131975 A1
(43) Pub. Date: Jun. 22, 2006

(54) Longitudinally-fluted multi-pole permanent-magnet rotor

(76) Inventors: Cheng-Lung Lee, Taipei Hsien (TW); Tung-Yen Li, Taipei Hsien (TW); Tso-Lun Wu, Taipei Hsien (TW)

Correspondence Address: LIN & ASSOCIATES INTELLECTUAL PROPERTY, P.O. BOX 2339, SARATOGA, CA, 95070-0339, US

(21) Appl. No.: 11/312,322

(22) Filed: Dec. 20, 2005

(30) Foreign Application Priority Data
Dec. 20, 2004 (CN) 200410101455.9

(51) Int. Cl. H02K 21/12

(52) U.S. Cl. 310/156.43

(57) ABSTRACT

A rotor having a longitudinally-fluted and multi-pole configuration is used in a motor to enhance torque output of the motor. The rotor includes a shaft around which a magnetic member is fixed. The magnetic member is molded with a mixture of plastics and magnet powders and forms a plurality of radially-projecting and longitudinally-extending sections, each of which defines a magnetic pole, and a plurality of longitudinally-extending flutes alternating and circumferentially spacing the pole sections from each other. The pole sections are arranged to have opposite polarities for adjacent pole sections.

### BACKGROUND OF THE INVENTION

1. Field of the Invention

The present invention relates generally to a permanent magnet rotor, and in particular to a cylindrical rotor forming a plurality of longitudinally-extending in an outer circumference thereof.

2. The Prior Arts

A motor is comprised of a rotor and a stator. The rotor can be arranged inside and surrounded by the stator. A conventional internal rotor is illustrated in FIG. 1 of the attached drawings, wherein a cylinder magnet comprised of a number of magnetic poles 11 is mounted to a shaft 12 about which the magnet rotates. The magnetic poles 11 are formed by magnetization after the cylinder magnet is formed around the shaft 12. Magnetic flux runs between adjacent opposite poles 11 of the magnet. It is noted that only a portion of the magnetic flux is shown in the drawings.

The conventional permanent magnet rotor suffers a transition between adjacent opposite poles 11 in which the magnetic flux runs substantially in the circumferential direction of the cylinder magnet, rather than in a radial direction and perpendicular to the cylindrical surface of the magnet. This reduces the magnetic force induced in the transition zone. Further, since magnetization is not often done in a very precise manner and thus the angular arrangement of the magnetic poles 11 along the circumference is not precise. For example, in the conventional rotor illustrated in FIG. 1, four poles, including two north poles and two south poles alternating each other, are arranged along the circumference of the rotor. Theoretically, an angular spacing or “pitch” between adjacent poles is exactly 90 degrees, which is equal to 360 degrees divided by four. However, it is very difficult, if not impossible, to achieve such a precise spacing between adjacent poles in an actual rotor. Such impreciseness leads to poor control of the rotation of the rotor, preventing the rotor from being employed in operation of high precision. FIG. 7 of the attached drawings shows a plot of the magnetic flux density for the conventional rotor. The distribution of the magnetic flux density of the conventional rotor takes the form of a sinusoidal wave. This indicates that angularly shifting of the theoretical interfacing line between adjacent opposite poles can easily happen if the magnetization is not performed very precisely.

FIG. 2 of the attached drawings shows another conventional rotor, which comprises a shaft 12 and four previously-shaped permanent magnets 13 having north and south poles 11 mounted to an outer circumference of the shaft 12 with opposite poles 11 alternating each other. Such a rotor construction allows for very clear and precise interfacing line between adjacent poles and no transition exists between adjacent poles. Thus, control of rotation of the rotor can be very precise. Further, the magnetic flux is always perpendicular to the outer circumferential surface, which allows for better utilization of the magnetic power.

However, the manufacturing process of the rotor shown in FIG. 2 is complicated. Further, it is hard to precisely align the outer surfaces of the individual magnets 13 with each other so that it is hard to provide a continuous, smooth outer circumferential surface for the rotor. In other words, the outer circumferential surface of the rotor may comprise separated raised portion due to unalignment between adjacent magnets 13, which may accidentally hit the stator that surrounds the rotor during the rotation of the rotor. Thus, the stator must be kept at a larger radial distance from the rotor in order to avoid the undesired hitting. This easily leads to leakage of magnetic flux and deteriorates the performance of the rotor/stator. Further, the magnets and the shaft are separate parts that are manufactured separately and then bonding together. This construction suffers undesired separation of the magnets from the shaft after a long term operation thereby shortening the service life of a motor comprised of the rotor.

FIG. 3 of the attached drawings shows another known rotor, in which four magnets 14 are embedded in the rotor. This effectively eliminates the risks of separation of the magnets from the rotor and the unalignment problem. However, the manufacturing process is very complicated. Further, the magnets are spaced from the outer circumferential surface of the rotor, which deteriorates the performance.

U.S. Pat. No. 6,765,319 disclosed another conventional rotor, which is illustrated in FIGS. 4 and 5 of the attached drawings. The rotor has a unitary member 15 that is fit over a shaft 16. The unitary member 15 is magnetized to form four pairs of radially-directed north-south poles 15a, 15b, 15c, and 15d. The unsmooth surface problem is thus avoided. However, since there is no sharp interfacing between circumferentially adjacent poles, a transition exists between the circumferentially adjacent poles, leading to deterioration of performance. Also, the magnetic flux is not oriented in a direction substantially normal to the outer circumference of the rotor.

U.S. Pat. No. 3,419,740 discloses another known rotor, which is illustrated in FIG. 6 and designated with reference numeral 18 comprising a body 180 having radial projections. Appendages 181 made of permanent magnets are attached to radial free ends of he projections. The body 18 is fixed to a shaft 19, which drives the rotation of the body 18 and the appendages 181. The manufacturing process is apparently very complicated as compared to the other known rotors.

Thus, the present invention is aimed to provide a rotor of which the magnetic flux is substantially normal to an outer circumference of the rotor and circumferentially adjacent poles of the rotor are clearly distinct, with magnets securely fixed to a shaft of the rotor to enhance service life thereof.

### SUMMARY OF THE INVENTION

An objective of the present invention is to provide a longitudinally-fluted multi-pole permanent-magnet rotor, wherein circumferentially adjacent poles are spaced and thus effectively isolated to allow for precise control of rotation of the rotor by a counterpart stator.

Another objective of the present invention is to provide a longitudinally-fluted multi-pole permanent-magnet rotor wherein circumferentially adjacent poles are isolated from each other by an angular spacing whereby magnetic flux is in a direction substantially normal to an outer circumferential surface of the rotor, thus enhancing torque generated by a motor employing the rotor.

A further objective of the present invention is to provide a longitudinally-fluted multi-pole permanent-magnet rotor having an integrally formed and thus sound and reliable structure to ensure extended service life.

Yet a further objective of the present invention is to provide a longitudinally-fluted multi-pole permanent-magnet rotor having poles distributed along a circumference of the rotor at identical radial distance from a rotational axis thereof, whereby a radial gap between the rotor and a counterpart stator can be maintained as small as possible without risk of undesired impact therebetween and the magnetic reluctance is minimized and performance is enhanced.

In accordance with the present invention, a longitudinally-fluted multi-pole permanent-magnet rotor is provided, comprising a shaft arranged along a longitudinal axis and a unitary magnetic member around the shaft and forming a plurality of longitudinally-extending and circumferentially-spaced projections that are substantially parallel to the longitudinal axis and each serving as a magnetic pole, adjacent poles being of opposite polarities. Each pole section has an active outer surface that is curved as a sector of a cylindrical configuration of the rotor and the active outer surfaces of the pole sections are all at identical radial distance from the longitudinal axis. The pole sections are spaced from each other by a longitudinally extending flute defined in the outer circumference of the rotor for effectively isolating the poles from each other

Due to the isolation between adjacent pole sections effected by the longitudinally extending flute, the poles of the rotor can be precisely positioned and clearly distinct, resulting in precise control of the magnetic force acting on the pole by a counterpart stator. In addition, the magnetic flux running among the poles is not mutually interfered with each other and is thus substantially directed normal to the outer circumference of the rotor to enhance the effective magnetic flux. Further, the poles are integrally formed as a unitary member, which can be done with a simple process, and the poles can be positioned at precisely identical distance from the longitudinal axis of the rotor. Thus, radial gap between the rotor and the counterpart stator can be minimized without risk of impact and the flux leakage is also minimized, which in turn improves the performance thereof.

The present invention will become more obvious from the following description when taken in connection with the accompanying drawings, which show, for purposes of illustration only, preferred embodiments in accordance with the present invention. In the drawings:

### BRIEF DESCRIPTION OF THE DRAWINGS

FIG. 1 is a schematic view of a conventional rotor;

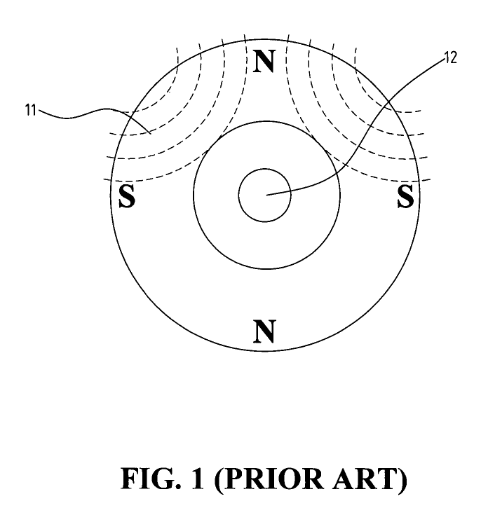

FIG. 2 is a schematic view of another conventional rotor;

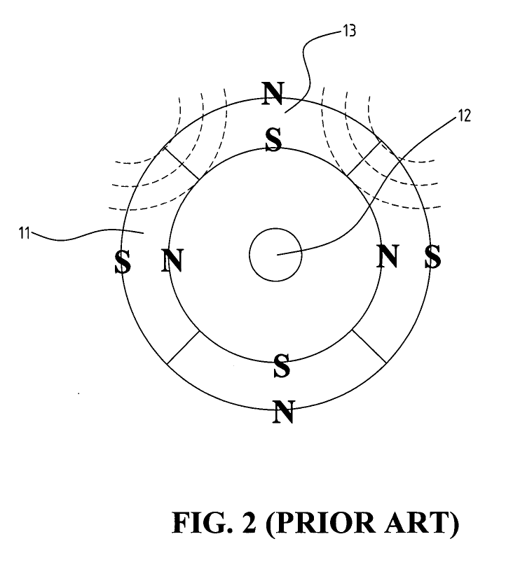

FIG. 3 is a schematic view of a further conventional rotor;

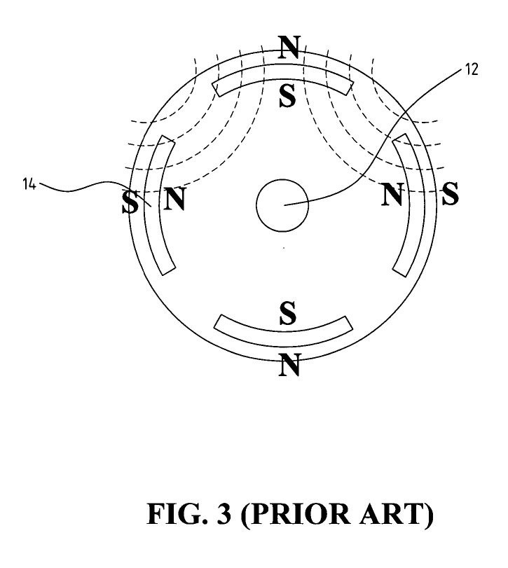

FIG. 4 is a schematic view of yet a further conventional rotor;

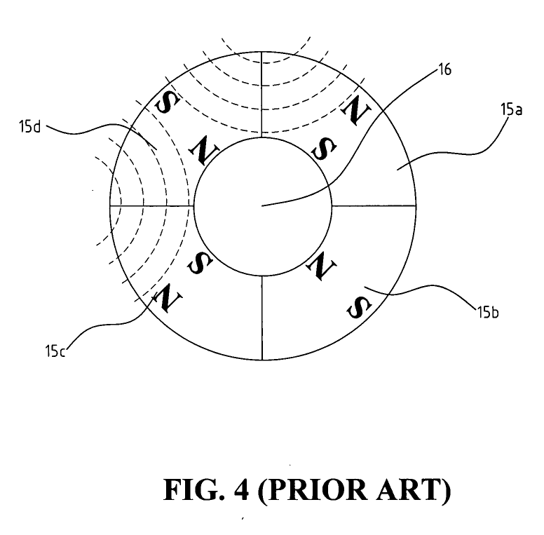

FIG. 5 is a cross-sectional view of the conventional rotor shown in FIG. 4;

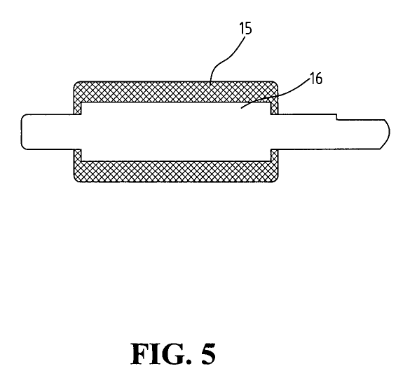

FIG. 6 is a perspective view of yet a further conventional rotor;

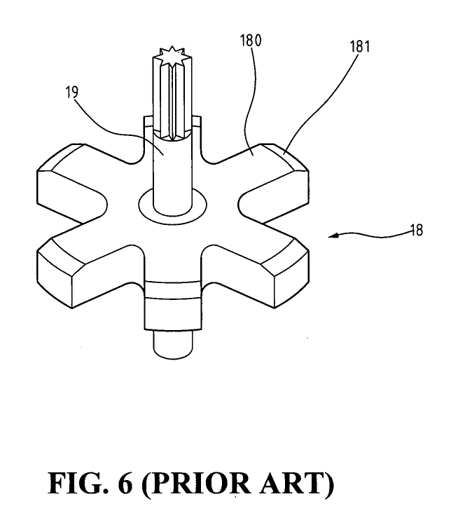

FIG. 7 shows the distribution of the magnetic flux induced by the conventional rotor illustrated in FIG. 1;

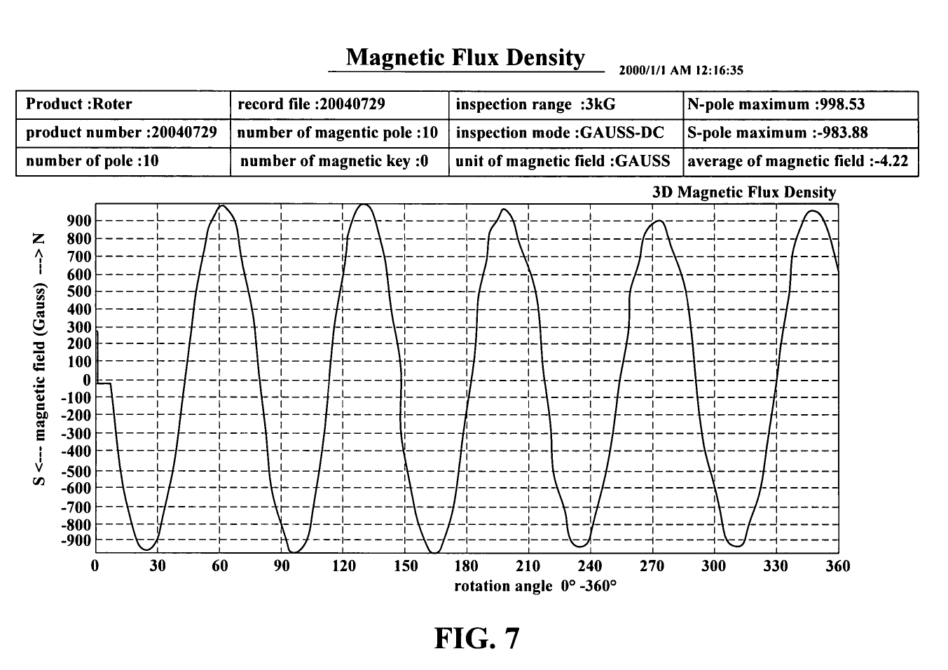

FIG. 8 is an axial end view of a rotor constructed in accordance with a first embodiment of the present invention;

FIG. 9 is a perspective view of the rotor of the present invention;

FIG. 10 is a distribution curve of the magnetic flux induced by the rotor of the present invention;

FIG. 11 is an axial end view of a rotor constructed in accordance with a second embodiment of the present invention; and

FIG. 12 is a perspective view of the rotor in accordance with the second embodiment of the present invention.

### DETAILED DESCRIPTION OF THE PREFERRED EMBODIMENTS

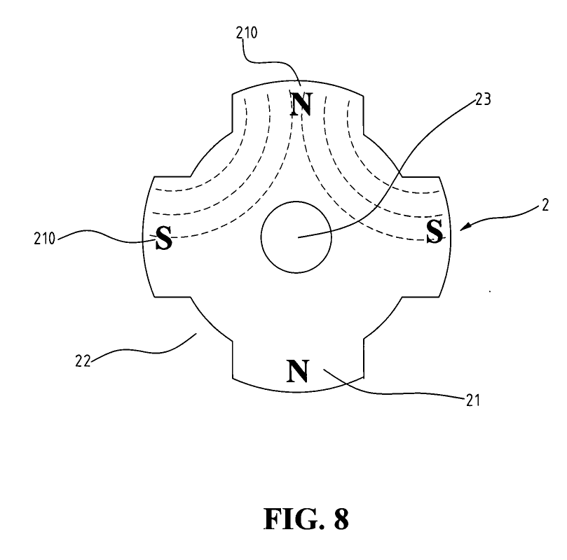

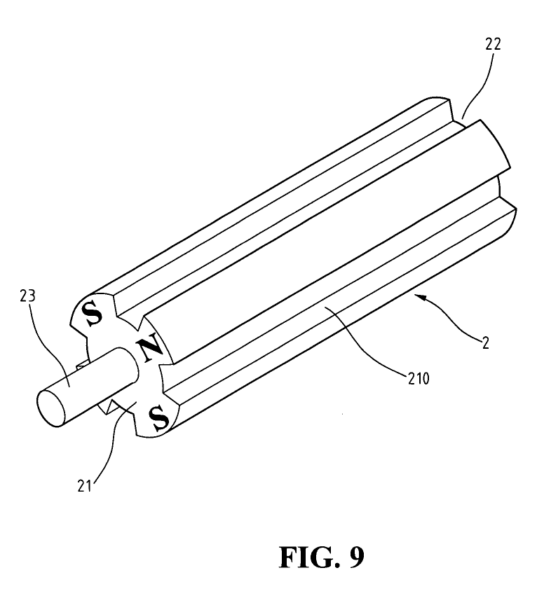

With reference to the drawings, and in particular to FIGS. 8 and 9, a longitudinally-fluted multi-pole permanent-magnet rotor constructed in accordance with a first embodiment of the present invention, generally designated with reference numeral 2, comprises a shaft 23 having a longitudinal axis or rotational axis and an integtally-formed unitary magnetic member 21 encompassing and fixed to the shaft 23 to be rotatable in unison therewith. The magnetic member 21 forms a plurality of magnetic poles, for example four poles in the embodiment illustrated including two north poles and two south poles alternating each other, arranged along an outer circumference of the magnetic member 21. The rotor can be manufactured with any know process. As an example, the shaft 21 is provided in advance and is positioned in a cavity of a mold (not shown) in which plastics mixed with magnet powders is filled to surround the shaft 23. The plastics and magnet powder mixture is magnetized while the mixture is being cured. Thus, the mixture, once cured, forms a plastic body containing magnet powders surrounding the shaft 23 and the magnetic member is formed integrally.

In the embodiment illustrated, the magnetic member 21 is formed as a cylinder fit over the shaft 23 and has a plurality of radially-projecting sections 210 spaced along an outer circumferential of the rotor. Each pole section has an active outer surface, curved as a sectorial portion of the rotor, defining a magnetic pole. The pole sections, or the active outer surfaces of the pole sections, are circumferentially spaced by flutes 22 that are formed in the outer circumferential surface of the rotor and extend longitudinally or axially.

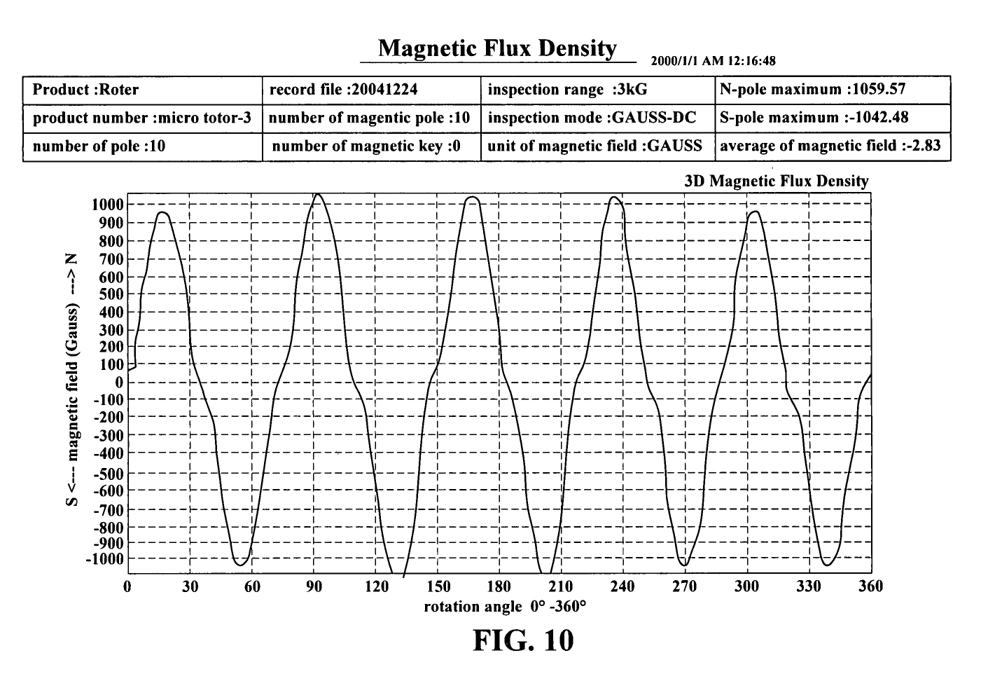

The flutes 22 effectively isolate the pole sections 210 from each other. This can be clearly observed from the distribution curve of the magnetic flux of the rotor 2 as shown in FIG. 10. Clearly enough, the magnetic flux at positions corresponding to the flutes 22 is substantially zero over quite an angular range. Thus, adjacent poles are clearly distinct and no angular shifting of the poles may occur, which leads to more precise control of the rotation of the rotor 2 when the rotor 2 is driven by a counterpart stator (not shown).

The flutes 22, which effectively isolate the pole sections 210 from each other, direct the magnetic flux substantially normal to the active surfaces of the pole sections and thus further enhance the operation performance. In addition, the manufacturing process for the integrally formed magnetic member is simple and the structure is sound and reliable, leading to extended service life.

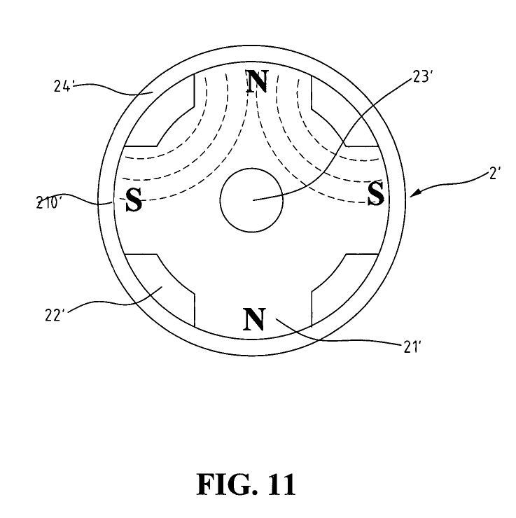

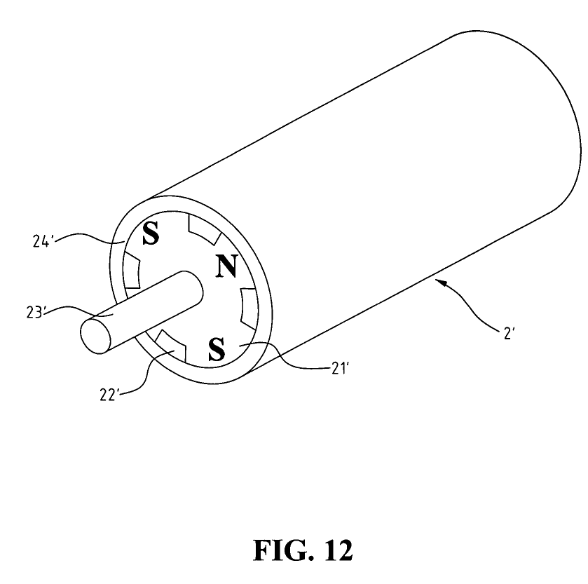

FIGS. 11 and 12 show a rotor constructed in accordance with a second embodiment of the present invention, which is designated with reference numeral 2′ for distinction. The rotor 2′ comprises a shaft 23′ over which an integrally formed magnetic member 21′ is tightly fit over to be rotatable in unison therewith. The magnetic member 21′ is made by compression molding and forming a plurality of angularly (or circumferentially) spaced pole sections each having a curved active outer surface 210′ separated by longitudinally (or axially) extending flutes or recesses 22′. A non-ferromagnetic material is filled in the recesses 22′ and forms a continuous, breakless cylindrical outer surface. The continuous, smooth outer surface of the rotor allows a counterpart stator to be positioned very closed to the rotor without any risk of impact therebetween during the rotation of the rotor.

A protective sheath 24′ surrounds and encloses the rotor 2′ to reduce resistance against rotation of the rotor 2′.

In the second embodiment discussed with reference to FIGS. 11 and 12, the magnetic member 21′ is formed with a central bore (not labeled) into which the shaft 23′ is fit, after the magnetic member 21′ is formed.

The above discussed construction of the rotor 2 (2′) has an integrally formed magnetic member 21 (21′), which is directly formed around the shaft 23 or later fit over the shaft 23′. The manufacturing process is simple and the control of the rotor 2 (2′) can be very precise due to the flutes or recesses 22 (22′) formed between the pole sections or active surfaces 210 (210′) of the magnetic member that clearly distinguish the poles from each other. Effective magnetic flux is enhanced and a motor employing the rotor 2 (2′) may have an increased torque output.

Although the present invention has been described with reference to the preferred embodiments thereof, it is apparent to those skilled in the art that a variety of modifications and changes may be made, for example replacing the bowl with a fork, without departing from the scope of the present invention which is intended to be defined by the appended claims.

What is claimed is:

1. A rotor comprising:
a shaft having a longitudinal axis; and
a magnetic member fixed around the shaft to be rotatable in unison with the shaft, the magnetic member comprising a plurality of radially-projecting and longitudinally-extending sections each defining a magnetic pole, adjacent sections being of opposite magnetic polarities, each section having an active outer surface at an identical distance from the longitudinal axis, the pole sections of the magnetic member being circumferentially spaced from each other by alternately formed flutes that extend longitudinally.

2. The rotor as claimed in claim 1 further comprising a non ferromagnetic material filled in each flute whereby the magnetic member forms a continuous, smooth outer surface.

3. The rotor as claimed in claim 2 further comprising a protective sheath fit over the outer surface of the magnetic member.

4. The rotor as claimed in claim 1, wherein the magnetic member forms a bore into which the shaft is fit.

5. The rotor as claimed in claim 1, wherein the magnetic member is molded around the shaft to fix together.
